(19) United States
(12) Patent Application Publication
(10) Pub. No.: US 2004/0170799 A1
(43) Pub. Date: Sep. 2, 2004

(54) Heat-insulating material and method of making the same

(76) Inventors: Roger Carr, Saco, ME (US); Marsha Ard, Greenville, AL (US); David England, Lanett, AL (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/377,073

(22) Filed: Feb. 28, 2003

(51) Int. Cl. B32B 3/02; B05D 1/14; B05D 1/36

(52) U.S. Cl. 428/90; 428/88; 428/89; 428/196; 427/258; 427/261; 427/180; 427/200; 427/202; 427/206

(57) ABSTRACT

The invention relates to a heat-insulating material acceptable for use, such as a bed blanket. The heat-insulating material has a reinforcing layer, a base layer bonded to the reinforcing layer, and flock fibers secured to the exposed surface of the base layer through a discontinuous coating of cured adhesive. The base layer can have a thickness of less than 0.0625 inch. The flock fibers can have a diameter in the range from about 3 denier to about 4 denier. The invention also relates to a method of making the heat-insulating material by providing a laminate of a reinforcing layer and a base layer of a thickness less than 0.0625 inch, wherein the reinforcing layer and the base layer are permanently united to each other; providing an adhesive of a viscosity such that when applied to the exposed surface of the base layer it will remain on the exposed surface without substantial spreading or penetration into the base layer to any substantial depth; depositing the adhesive on the exposed surface of the base layer, with a printing roll having a discontinuous surface, in the form of a discontinuous coating; and distributing flock fibers evenly over the discontinuous adhesive coating before the adhesive sets.

### FIELD OF THE INVENTION

The present invention relates generally to heat-insulating materials of lamellar structure. In addition, the present invention relates to a method of making heat-insulating material of lamellar structure.

### BACKGROUND OF THE INVENTION

In general, the application of flock to a base fabric to provide a suede-like finish and apparatus for doing so on a commercial scale are known. Commonly, such apparatus comprises a support or table over which the base fabric is drawn, the base fabric having been so treated that its upper face is adhesive for retention of the flock fibers. Above this table or support there is a receptacle for flock fibers, the receptacle having slots or other openings through which the flock fibers can fall, and within the receptacle there is usually an elongated rotating screw, or similar device, which agitates the flock fibers and sweeps them across the openings through which the flock fibers drop down onto the adhesive surface of the base fabric. Beneath the base fabric so-called “beaters” are located which set up rapid vibrations in the base fabric such as to assist in causing the fibers to assume an upright position as they approach the adhesive. As a further means for assuring the upright position of the flock fibers, it has been known to provide an electrical device which creates a high tension electrostatic field through which the fibers pass in approaching the adhesively-coated base fabric, thus tending to cause the fibers to separate and become parallel and perpendicular. The latter arrangement is disclosed in U.S. Pat. No. 3,379,175 issued to Spencer on Apr. 28, 1968.

U.S. patent application Ser. No. 565,235 of Francis T. Spencer filed Jul. 14, 1966 describes an apparatus similar to customary flocking mechanisms but modified so that, unlike most prior apparatus, it distributes fibers from the reservoir in such quantity per unit of time as to provide a flock of predetermined density, and arranges the flock so delivered in accurate, uniform distribution over the surface of a base material which can be of a dimension sufficient to form a blanket of maximum width.

It was suggested that a composite substrate comprising textile material and a layer of “reticulated” plastic foam be provided as a base for the attachment of flock fibers. Reasons given for the use of reticulated foam have been based on the theory that because throughout the open cells of the reticulated foam, the end of a flock fiber will drop down onto an open cell and as liquid adhesive will also enter the open cell, an appreciable length of the flock fiber will be embedded in the adhesive and firmly anchored to the base fabric. However, it should be remembered that the cost of flock fibers rapidly increases with increased length. If a substantial fraction of the length of the customary very short fibers were thus sunken in the base material, the resultant flock layer would be undesirably thin, and it would be necessary to use flock fibers of a substantially greater length than would otherwise be required in order to provide the desired depth of nap, thus increasing the cost for the flock material. Furthermore, the setting of adhesive within the deep open cells of the foam would add very substantially to the stiffness of the material and thus decrease its value for the purpose intended.

In the manufacture of flocked fabric, for example, carpeting, it is usual to employ fibers of up to 8 denier and to arrange them very closely so as to make a firm, dense, stiff, wear-resistant material. The length of the flock fibers can range from 2 mm to 6 mm. The weight of flock fibers per square yard of a good grade of blanket material can be within the range of from 0.075 oz. to 4.0 oz.

### SUMMARY OF THE INVENTION

This invention provides a heat-insulating material and a method of making the same. The heat-insulating material of the invention can comprise a base layer, at least one surface of which is bonded or partially bonded by a layer of flock fibers as will be described below. The base layer can have a thickness of less than 0.0625 inch. The major portion of the base layer can comprise such a material that has the requisite physical and chemical characteristics of a heat-insulating material and contributes to the heat-insulating properties of the heat-insulating material of the invention. The base layer can be printed, dyed, colored, or otherwise processed to form a pattern thereon. The adhesive employed to bond the flock fibers to the base layer can provide such a bond that the completed heat-insulating material can withstand laundering and rough handling without shedding nap, and resist color change when the material is exposed to ultraviolet light.

The flock layer of the heat-insulating material can not only function as a heat insulation but also be pleasing to the eye and soft to the touch. According to the invention,. the flock fibers can have a diameter of more than 3 denier but no more than about 4 denier. If desired, the fibers can be arranged much less densely than is customary in carpet fabric. Merely by way of example, the weight of flock fibers per square yard of a good grade of the blanket material can be within the range of from about 0.075 oz to about 4.0 oz. According to the invention, the flock fibers can be made of various materials, such as polyester or nylon. Additionally or alternatively, the flock fibers can be transparent or otherwise non-opaque to reveal the color and pattern formed on the underlying base layer and/or by the adhesive.

Before the flock is applied, the basic material can be treated as hereinafter described, to make it permanently soft. After the flock is applied as above described, the material is cured so as to set the adhesive, for example, by passing it through an oven heated to the proper temperature. The napped surface can be brushed to remove unattached fibers, and softened to neutralize stiffening resultant from curing, for example, by a treatment hereinafter described.

By variation in the length and/or the diameter of the individual flock fibers constituting said fibrous or nap layer, the heat-insulating material can be adapted to a wide variety of uses, for example, for bed blankets of many grades or outdoor apparel liners such as jackets and pants. With respect to the suggested utility of a bed blanket, a material must possess those characteristics which are customarily expected in such a blanket, such as the desired warmth, softness, drapeability, and durability under conditions of use, e.g., in laundering. Moreover, a blanket material is desirably light in weight and pleasing in appearance and feel, that is to say, it must be of a “soft hand.” Further, a blanket material must not readily shed its nap fibers when exposed to handling or stressful treatment.

The heat-insulating material of the invention can be used as a bed blanket material. The material of the invention has a durability that exceeds or is at least equal to that of customary woven blanket material. The material of the invention is comparable in warmth and softness to the blanket materials made by other methods and is more pleasing to appearance, lighter in weight, and softer to the touch than many previously known blanket materials having equal heat-insulating properties. The material of the invention can have a napped surface.

While the heat-insulating material of the invention can be used as “a blanket material,” the material can also be made so thin and drapeable that it could be used, for example to make garments. For example, only one ply of foam can be provided, the reinforced fabric then being visible at one side of the fabric. In this instance it is obvious that the reinforced material or webbing should be of sufficiently small mesh to afford good anchorage for sewing stitches. When provided with ornamental patterns in contrasting colors, the heat-insulating material makes an acceptable drapery, as above suggested, or constitutes a desirable upholstery fabric.

To obtain ornamental colored patterns in the heat-insulating material, the invention provides that any desired color effects can be obtained by coloring or printing the base layer, or by using a colored adhesive, or by using a colored base layer, resulting in numerous color and pattern variations.

### BRIEF DESCRIPTION OF THE DRAWINGS

The detailed description of the present invention will be better understood in conjunction with the accompanying drawings, wherein like reference characters represent like elements, as follows:

FIG. 1 is a fragmentary cross-sectional view of the heat-insulating material of the present invention;

FIG. 2 is a view similar to FIG. 1, but showing an alternative embodiment;

FIG. 3 is a view similar to FIG. 2, but showing a third embodiment;

FIG. 4 is a fragmentary cross-sectional view of a fourth embodiment;

FIGS. 5 and 6 are plan views of the reinforcing layer;

FIGS. 7 and 8 are fragmentary plan views the heat-insulating material;

FIG. 9 is a fragmentary elevation illustrating a roll used for applying adhesive to the base layer;

FIG. 10 is a fragmentary radial cross-sectional view through the roll of FIG. 9;

FIG. 11 is a fragmentary diagrammatic end elevation, showing apparatus, including the roll of FIG. 9, illustrative of its mode of use;

FIG. 12 is a fragmentary plan view of the roll of FIG. 9 showing the channels;

FIG. 13 is a fragmentary vertical cross-sectional view through a piece of the flocked material such as results from the practice of applying the adhesive by the use of a roll similar to that of FIG. 9;

FIG. 14 is a fragmentary perspective view illustrating a modification of the adhesive-applying roll of FIG. 9 (useful in the apparatus of FIG. 11 in substitution for the roll 9), illustrating how the fabric can be ornamented to give it the appearance of having been embossed; and

FIG. 15 is a flow sheet indicating certain desirable sequences of steps which can be employed in the process of making the improved material of the present invention.

### DETAILED DESCRIPTION OF THE INVENTION

Exemplary heat-insulating material and methods of making the same embodying the principles of the present invention are shown throughout the drawings. In the following description of various embodiments of the heat-insulating material, similar elements or components thereof are designated with reference numbers that have the same last two digits and redundant description is omitted.

Briefly stated and without at this point elaborating upon the details of the method of making the heat-insulating material, the material can comprise a base layer. In a preferred form (FIG. 1), two base layers can be provided, which can join to each other in various manners. In an exemplary embodiment, the two base layers can be interposed and joined to a reinforcing layer as will be described below.

The heat-insulating material of the invention can further comprise a layer of flock fibers, which can be adhesively bonded to at least one surface of the base layer. In one embodiment, the flock fibers can bond to the exposed surface of one or both of the base layers and be adapted to cover at least a portion of the exposed surface of one or both of the base layers. By the employment of a suitable adhesive such as hereinafter more fully set forth, it is possible to anchor the flock fibers adequately and permanently to the base layer. However, even though the layer of adhesive for anchoring the flock fibers be of but small depth, this layer of cured adhesive, as usually applied, does form a continuous skin adherent to the surface of the base layer and thus does have an appreciable effect in stiffening the material. Avoidance of even this slight stiffening can be achieved as hereinafter more fully described, by so applying the adhesive as to form a discontinuous skin or layer whose discontinuity appreciably adds to the flexibility of the completed material. Careful experiment has shown that this procedure does not detract from the surface appearance of the flock layer nor appreciably reduce the insulating characteristics of the material.

As shown in the drawings, the base layer 10 can be formed of various materials, such as a heat insulator. For example, the base layer 10 can be a synthetic plastic foam, and more especially ordinary open-cell commercial polyurethane foam which is preferable. In an exemplary embodiment, the base layer 10 can be made of an open-cell, low density polyurethane foam. Not only is open-cell foam a good heat-insulator, but it is soft, limp and drapeable so that the resultant material has the basic qualifications, as to heat insulation and drapeability, demanded of acceptable blanket material. In an embodiment where two base layers 10a and 10b are provided, such base layers 10a and 10b can be made of the same material or different materials. For example, each base layer 10a or 10b can be formed of a commercial polyurethane foam or other materials with heat-insulating properties.

The base layer 10 of the heat-insulating material 1 can have various thickness. In one embodiment, the thickness of the base layer 10 can be less than 0.0625 inch. In an exemplary embodiment, the base layer 10 can have a thickness of about 0.060 inch or less. In another embodiment, the thickness of the base layer 10 can be about 0.055 inch or more. In an exemplary embodiment, the base layer 10 can have a thickness of about 0.059 inch, about 0.058 inch, about 0.057 inch, or about 0.056 inch, respectively. In another embodiment where two base layers 10a and 10b are employed (FIG. 1) they can, if desired, be of the same thickness or on the other hand different thickness. In an exemplary embodiment, each of the two base layers can be less than 0.0625 inch in thickness, thus providing an aggregate thickness of less than 0.125 inch. In another exemplary embodiment, the two base layers can have a thickness of about 0.060 inch and about 0.055 inch, respectively, thus providing an aggregate thickness of about 0.15 inch.

The reinforcing layer 11 can be made of various materials to form a strong and tough foundation, substrate or reinforced fabric. In one embodiment, this reinforcing layer 11 can comprise independent spaced textile threads, or of textile yarns or threads concatenated according to any well-known textile procedure to form a coherent fabric, for instance a woven fabric (FIG. 5). In another embodiment, such reinforcing layer 11 can be of very open-mesh to avoid undue weight. For example, the reinforcing layer 11 can have from 75% to 97% voids. In an exemplary embodiment, the reinforcing layer 11 can be a cotton scrim of an open-mesh providing from 90% to 97% voids has proven satisfactory. In another exemplary embodiment, the reinforcing layer 11 can be a webbing having a lesser percentage of voids with reasonably good results, for example 75% voids, particularly if the constituent yarns be very fine and strong as, for example, silk. Desirably, this reinforcing layer 11 can have a minimum tensile strength of approximately 20 pounds per inch, both longitudinally and transversely and weigh from approximately 6.4 to 10.0 ounces per square yard.

The reinforcing layer 11 can be associated with the base layer 10 in various manners. For example, the reinforcing layer 11 can overlay at least a portion of one of the two surfaces of the base layer 10 and be fixed thereonto. In one embodiment, the reinforcing layer 11 can overlap the entire surface of one side of the base layer 10. In an embodiment as illustrated in FIG. 1, the reinforcing layer 11 can be interposed between two base layers 10a and 10b and bonded thereto.

Having prepared the base layer 10 and the reinforcing layer 11, these parts can be brought into assembled relation in any desired way and laminated together by a conventional water insoluble adhesive, although conventional flame bonding might be used. As hereinafter more fully described, this laminate can be treated, at this point, to make it permanently soft.

The flock fibers F (FIG. 1) can be made of any desired materials, such as those that are not readily absorbent of water. Exemplary flock fibers F can include, but are not limited to, silk, wool, cotton, rayon, a synthetic plastic substitute for wool, such as nylon or polyester, and the like. When cost is a controlling factor a relatively cheap cellulosic flock, such as cotton or rayon can be used. However, since cellulosic flock materials are highly water-absorbent, lose strength when wet, and, during laundering treatment, by contact with parts of the laundering apparatus, can be permanently crushed or bruised, it is desirable, when employing such fibers, to pretreat them with a water repellant, such as one of those which are commonly used to make garments rainproof.

In accordance with the present invention, the flock fibers F can have different sizes and still assure the desired softness and drapeability of the heat-insulating material 1. For example, the flock fibers F can be desirably from about 2 denier to about 4 denier. In an exemplary embodiment, the flock fibers can have a diameter of more than about 3 denier but no more than about 4 denier. In another exemplary embodiment, the flock fibers can have a diameter of about 2.2 denier or about 3.3 denier.

Additionally or alternatively, flock fibers F can have various lengths. The flock fibers F can comprise very short fibers (as compared with those usually resultant from the napping of a woven base fabric). For example, the flock fibers F can be those such as commonly referred to as “flock fibers.” In an exemplary embodiment, the flock fibers F can have a length within a range of from about 1.6 mm to about 1.9 mm. In one embodiment, the flock fibers F can be of uniform length rather than heterogeneous in length (as is true of the cheaper grades of flock) in order to obtain a flock layer which is substantially level. Such flock fibers F can be evenly distributed over the entire area of one surface of the base layer 10 and bond thereonto.

In another embodiment, two different lengths of flock fibers F can be employed to form the flock layer. The flock fibers F can comprise a relatively long fibers F1 (FIG. 3), for instance, of about 1.9 mm in length a shorter flock fibers F2, for example, of the order of about 1.6 mm in length. One of the two types of flock fibers F1, F2, such as the relatively long fibers F1, can be distributed uniformly and relatively sparsely over the entire area of the adhesively-coated base layer 10. Such long fibers F1 can collectively impart an attractive, nap-like appearance to the heat-insulating material 1. Then, the other type of the flock fibers, such as the shorter flock fibers F2, which are cheaper than the longer fibers F1, can be closely distributed over the entire area so as to fill in the spaces between the long fibers F1. These shorter flock fibers F2 can not only mask the base layer 10 but also contribute in substantial degree to the heat-insulating character of the resulting material 1.

Merely by way of example, the ratio of short and long fibers per square inch of material can be 75% short and 25% long, and the total weight of flock fibers, in ounces per square yard of the material, being within a range of from about about 0.075 oz to about 4.0 oz. However, when the cost is not a controlling factor, it is preferable, as above noted, to use flock fibers F of a single uniform length.

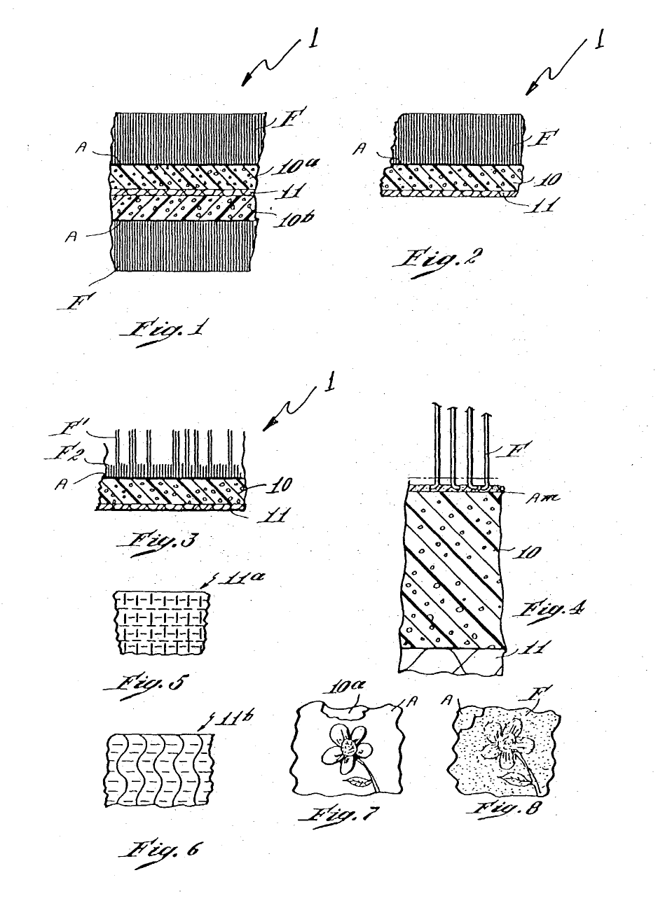

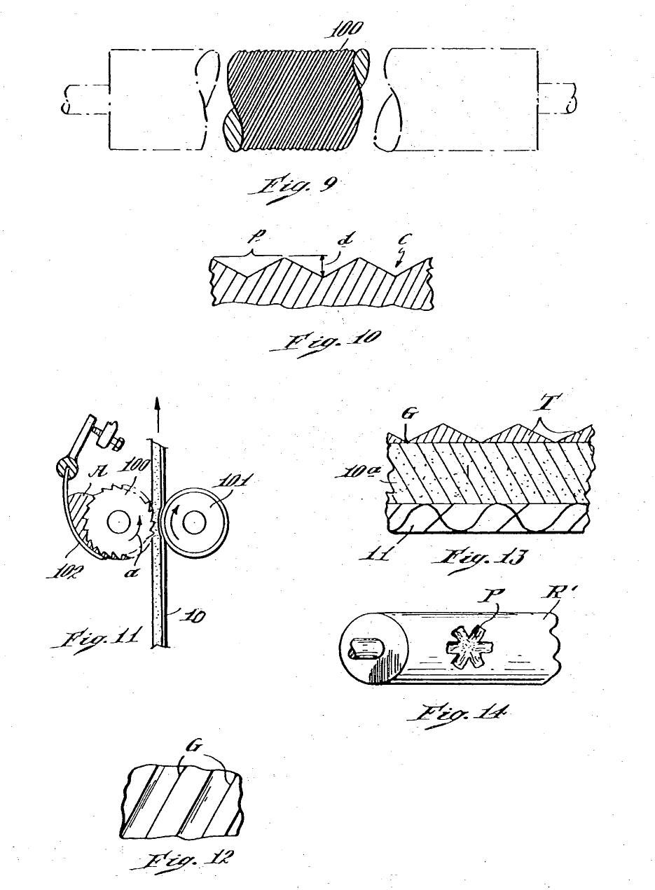

Preparatory to the application of the flock fibers F, the exposed surface of the base layer 10 will be coated with adhesive A (FIGS. 1 and 2).

In the course of experiment and extended tests of material made during the early stages in the development of the invention herein claimed, it was noted that when the material was exposed to ultraviolet light (as in a display window) and/or to elevated temperatures (such as are involved in curing the flock-bonding adhesive), it changed in color, in particular, the base layer became of an undesirable yellow shade. It was also observed that the adhesives which were initially employed for bonding the flock fibers to the base layer transmitted ultraviolet light to the base layer, although the adhesive itself was not chemically change or discolored. In seeking for the cause of this discoloration it was recalled that the manufacturers of acrylic polymer adhesives customarily recommend, to the user, the addition of acid salt-complex or metallic salt-complex catalysts as helpful in reducing the time required for curing the adhesive and that this recommendation had been followed in preparing the adhesives used during experimental work for bonding the flock fibers to the base layer. Tests showed that if such a modified adhesive were exposed to temperatures above 275° F., or to ultraviolet radiation, the salt-complex catalysts would break down with an intermolecular reaction and reduction of the melt temperature and that when the blanket comprised such a catalyst, the yellowing of the base layer was very pronounced; whereas if the catalysts were omitted from the adhesive but little discoloration occurred.

As to the recommended adhesive employed for bonding the flock fibers to the base layer, it should be noted that it is not sufficient, in attempting to produce a non-shedding material, merely to create an initially strong bond between flock and base layer, but the bond must withstand repeated and severe laundering; it must not be affected adversely by exposure either to heat or cold; it must not be so stiff when cured that it renders the fabric boardy; it must be capable of firmly entrapping a suspended dye stuff employed to impart color to the fabric; and it must not discolor either of itself or through some chemical action such as can be produced by exposure to high temperature or ultraviolet light.

An ideal adhesive for the purpose should, as shown by extended experiment, be free of acid salt-complex or metallic salt-complex catalysts; desirably, it should have a viscosity of the order of less than about 5 cps, and a pH value of from about 4.0 to about 4.5; it should produce, when cured, a colorless transparent film, and include an ultraviolet absorber thereby to protect the base layer from the action of ultraviolet light, and preferably it should comprise a defoamer.

As a basic adhesive, modified as hereinafter described, so as to have the above physical characteristics, one was selected (after many others had been tried) from the acrylic latex family group a self-cross-linking acrylic emulsion. Emulsions are described by Zimmerman and Levine in Supplement III in the 1953 edition of Handbook of Material Trade Names as follows:

“A group of aqueous dispersions of acrylic polymers. They are white, opaque liquids that produce colorless transparent films that possess excellent permanence properties, durability, adhesion, pigment-binding capacity.” . . . They are “useful for bonding textile fibers.”

This adhesive material, as supplied to the user, is an opaque liquid producing a colorless transparent film; it is substantially free of salt-complex catalysts; and is understood to have, inter alia, the following physical characteristics, viscosity at 25° C. 200 c.p.s.; solids content 46%; pH value 3.2; density at 25° C.—8.8 lbs. per gal.; film break-elongation load 620 lbs./sq. in.; and film hardness (A scale) 32 Shore.

This particular adhesive, as compared with many other adhesives, has been found to provide the best base with which to combine other materials in providing an adhesive having desirable characteristics. It will, of course, be understood that, in minor particulars, this base can vary to some extent as, for example, by reasons of the use of materials which can not in all cases be chemically pure, but, in general, an aqueous dispersion of acrylic polymers, having physical characteristics substantially as above set forth, can be expected to function in substantially the same manner. Such adhesive will thus hereinafter be referred to as the “base adhesive.” This basic adhesive is modified to produce an adhesive of such viscosity that it can be spread evenly over the surface of the base layer; will not penetrate deeply into the base layer but will still be sufficiently tacky to insure the adhesion of the flock fibers on contact, by adding to the basic adhesive (which contains only 46% solids), approximately 1 to 5 parts, based on the solids content of the acrylic latex, of a thickener. It was found by experiment that by adding 1.2% of either a polyacrylate or cellulosic thickener it was possible to obtain a product having a viscosity of the order of less than 5 cps. However, pH adjustment to 4.0 to 4.5 was found to be necessary when using the polyacrylate type of thickener. An ultraviolet absorber (for example, benzotriazole) more specifically, from 0.2% to 1.0% of 2-(2′-hydroxy-5′-methylphenyl)benzotriazole, and having an absorbability of between 290 and 400 millimicrons and which is stable as to degradation by ultraviolet radiation in the amount of 0.6% by weight was also added, and as a defoamer 0.27% of which is added. Thermostability to washing is thus achieved and a decrease in ultraviolet damage. The resultant modified basic adhesive has all the characteristics which are required in the production of material.

While that particular acrylic latex, when modified, has been found to give the desired results, it is to be understood that one is not necessarily limited to the use of this particular acrylic emulsion, as it is contemplated that other members of the acrylic latex family group, having generally similar physical characteristics can be used as the basic adhesive which, by modification, substantially as here described, will provide the physical characteristics above noted as desirable in such an adhesive.

As to the amount of the above or equivalent adhesive employed in bonding the flock to the plastic layer, the amount of adhesive per square yard can vary from 0.9 to 1.5 ounces and the thickness of the adhesive coating from 0.015 to 0.255 inch in the wet state. There is a direct relationship between the amount of flock fiber which can be attached and the amount of adhesive used. Since it is contemplated that a rather broad range of flock lengths and quality are to be provided, the amount of adhesive and the thickness of the coating can well vary within the ranges above described, and it will be understood that the above suggested range of weight and thickness of the adhesive coating can be extended under certain conditions especially with reference to the type of fiber employed.

In applying the flock fiber to the base layer, it is preferable to deliver the flock at a slightly greater rate than is necessary to produce the desired density, and then to collect those flock fibers which do not adhere to the base layer, and return them to the reservoir from which the flock is fed, thus insuring the desired density but without waste of material.

If the reinforcing layer be made of yarn which is glossy, so that it readily reflects light, the reinforcing layer will show through the completed material. Thus it is desirable to use a dull yarn (delustered), to wit, one which has a low index of reflection, that is, does not reflect light readily, in manufacturing the reinforcing layer.

Although the conventional adhesive layer for anchoring the flock fibers is of but small depth, this layer of cured adhesive, as usually applied, forms a continuous skin adherent to the surface of the base layer and thus does have an appreciable and undesirable effect in stiffening the material even though the base layer to be of the open-cell type. This disadvantage is overcome by so applying the adhesive as to form a discontinuous skin or layer whose discontinuity appreciably adds to the softness and drapeability of the completed material. Such a discontinuous layer is illustrated to a greatly enlarged scale in FIG. 10.

The adhesive is preferably applied by means of a rotary roll having a ribbed surface, the ribbed surface being constituted, for example, by a multiple screw thread of a pitch (p) of, for instance, 0.0345 inch and of a depth (d) of 0.008 inch, each thread being triangular in transverse section.

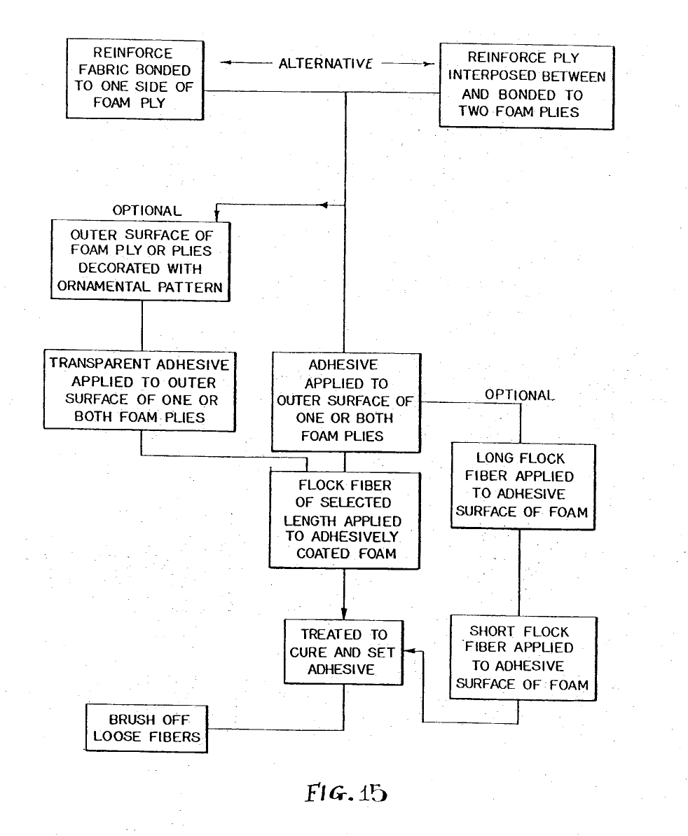

As illustrated in FIG. 11, the roll 100 which is power-driven in the direction of the arrow “a” has associated therewith a roll 101 which is resiliently urged toward the roll 100 so as to squeeze the reinforcing layer 11, which is fed between the rolls, with the base layer 10 opposed to the roll 100 so as to squeeze the base layer 10 against the roll 100. A body A of adhesive is maintained in the dihedral angle between the periphery of the roll 100 and a resilient blade 102 which so presses against the roll 100 that, as the latter approaches the compressed base layer 10, substantially, the only adhesive which it carries is that which is within the channels G of the roll. As the fabric emerges from between the rolls 100 and 101 the base layer 10 extends and in doing so, because of its spongy character, it picks up adhesive from the channels of the roll and carries it away. The result is that the layer of adhesive, as thus applied to the base layer, consists of a plurality of strips T (FIG. 13) greatly exaggerated in size in FIG. 13 of substantially triangular transverse section, the base of the triangle contacting the base layer 10 with little, if any, adhesive at the junction of the juxtaposed strips T. It is true that ordinary so-called “open-cell” polyurethane foam does have small, scattered, shallow, open-cells in its surface layer, and the action of the rolls 100 and 101 is to force some of the adhesive into some of these cells, but these cells are so small and shallow that this adhesive does not appreciably stiffen the foam, while the continuity of the adhesive layer is thus further broken. While theoretically there is a zero thickness of adhesive between adjacent strips T, the fluidity of the adhesive is such that there can be a film of adhesive along this line, but the fact that the layer of adhesive is almost, if not actually interrupted at these so frequent intervals, substantially nullifies any tendency of the cured adhesive to stiffen the base layer, and to all intents and purposes, the material behaves substantially as though the adhesive layer consisted solely of completely independent, very narrow strips arranged side-by-side. It is with this understanding that the adhesive layer is herein referred to as “discontinuous.”

The amount of adhesive applied by such a roll depends mainly upon the capacity of the channels to pick up adhesive. Thus, by providing rolls having channels of different depths or wherein the channels are spaced different distances apart, the amount of adhesive, per square yard of material, can be varied at will. A recommended arrangement, as the result of experiment, provides 28 channels per inch lengthwise of the roll, each of a depth of 0.008 inch, for example, and with the top edges of adjacent ribs 0.0345 inch apart.

Further, it appears that not less than twenty-five channels per inch (lengthwise) of the roll should be provided and as many as forty per inch have proven to be satisfactory. It has also been found that channels of different depths, for example, from 0.011 inches to 0.004 inch, depending upon the adhesive employed, provide a surface layer of requisite thickness.

The flock fibers when applied to this kind of adhesive layer adhere to the strips T of adhesive, but these strips are so narrow and close together and the flock fibers so overhang the intersections of the strips that the appearance is substantially identical with that which would be seen were the adhesive of uniform depth over the entire surface.

This procedure does not detract from the surface appearance of the flock layer nor appreciably reduce the insulating characteristics of the material.

For the production of a high degree of ornamentation and an artistic and pleasing appearance, the finished material can be provided with various colors, patterns, or other decorative forms. In one embodiment, the base layer can be provided with the various colors, patterns, or other decorative forms by various methods, such as printing, dying, coloring, painting, or the like. In an exemplary embodiment, before the flock fibers (desirably white or uncolored) are applied to the adhesive coating on the base layer (the adhesive, in this instance at least being transparent or translucent), the base layer can be passed through printing or equivalent apparatus whereby any desired pattern (FIG. 7) including multicolored floral patterns can be imprinted on the surface of the base layer. A preferred embodiment is accomplished by printing a pattern on the base layer utilizing pigment color. These printed patterns, in such color or colors as can be desired, show through the flock layer (FIG. 8) after it has been applied, with a delicate, muted appearance, giving an effect which is more artistic and pleasing than anything in the blanket field heretofore known. In an exemplary embodiment, the flock fibers can be transparent or otherwise non-opaque to reveal the colors and/or patterns on the underlying base layer. In another embodiment, an ornamental pattern is formed by areas substantially devoid of flock fibers, at which the surface color of the base layer is visible, imparting the suggestion of embossing.

If, on the other hand, it is desired merely to give a uniform color to the blanket, a colored adhesive can be employed for uniting the flock to the plastic.

In a further embodiment, by applying coloring material to the surface of the base layer and then so applying adhesive as to form an ornamental pattern while leaving other portions of the base layer without adhesive, the flock fibers will only stick to the areas constituting the pattern. As a result, the areas devoid of adhesive will exhibit the color of the base layer in full strength, while, at the flocked areas, the color is muted, and the areas of upstanding flock fibers impart the impression to the observer that the fabric is embossed.

The adhesive can be applied by means of apparatus generally like that shown in FIG. 11, employing a roll R′ (FIG. 14) having the desired pattern P in intaglio, so that the applied adhesive will have the ornamental pattern in cameo.

The application of flock will thus produce flock patterns standing up from the colored base layer surface, giving the appearance of embossing.

After the flock fibers have been applied and the adhesive cured, it is desirable to flex the material mechanically to soften it. Additionally or alternatively, a more permanent softening of the material can be obtained by treating the base layer with a vegetable oil, for example, coconut oil, as described below.

A dispersion of coconut oil and water in a proportion of approximately 7% coconut oil is prepared (preferably including a small quantity of a conventional rancidity inhibitor) and, before the adhesive and flock material have been applied, the material is wetted with this fluid, preferably by the use of a conventional padding apparatus, sufficient of the dispersion being applied so that after the material has been dried, as, for example, by passing it over customary drying cans, there remains in the dry material approximately 0.318 ounce of coconut oil per square yard. The base material, after this treatment, is coated with adhesive and before the adhesive has been cured the flock is applied as above described. When the adhesive has been cured, the oil is thereby confined and remains as a permanent constituent of the finished material. Material so prepared is soft and permanently drapeable, whereas, in accordance with the prior practice of beating the cured material to soften it, the material tends to gradually resume its initial stiffness during use. In order to prevent the completed material from becoming rancid it is desirable to add to the dispersion of oil and water a small amount of a substance which can permanently soften the finished material. For example, various commercially available anti-rancidity materials can be used as such a substance for permanently softening the finished material.

The resultant material has a combination of characteristics differentiating it from previous blanket materials; thus it is unusually light in weight; soft, very flexible, drapeable, not harmful to the skin; provides unusually high heat-insulation; dries very quickly after laundering; is dimensionally stable, that is, it does not shrink or deteriorate as a result of laundering; is almost completely non-shedding, that is, neither laundering nor long use causes appreciable loss of nap. It is inexpensive to manufacture as compared with blankets made from woven spun yarns, since the labor cost in operating machinery which is used is of the order of 1/10 that involved in the making of woven blankets, and its appearance and soft hand is more attractive than any previous blanket material (known to applicant) and it retains these characteristics after many launderings. Moreover, its color does not change to a substantial degree when exposed to ultraviolet light.

It will be appreciated that the various features described herein may be used singly or in any combination thereof. Therefore, the present invention is not limited to only the embodiments specifically described herein. While the foregoing description and drawings represent a preferred embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. A method of preparing a heat-insulating material, comprising
providing a laminate comprising a reinforcing layer and a base layer, said base layer having a thickness of less than 0.0625 inch and being permanently united to each other;
providing an adhesive of a viscosity such that when applied to an exposed surface of said base layer it will remain on said exposed surface without substantial spreading or penetration into said base layer to any substantial depth;
depositing a discontinuous coating of the adhesive on said exposed surface of the base layer, by means of a printing roll having a discontinuous surface;
distributing flock fibers evenly over said discontinuous adhesive coating before the adhesive sets.

2. The method according to claim 1 further comprising depositing the adhesive on said exposed surface of the base layer with a printing roll having surface discontinuities in the form of peripherally spaced grooves and ribs to form on said base layer surface a multitude of substantially independent closely adjacent parallel strips of adhesive interspersed with strips substantially bare of adhesive.

3. The method according to claim 1 further comprising applying adhesive to said exposed surface of the base layer with said printing roll in an amount of from about 0.9 ounces to about 1.5 ounces of adhesive per square yard.

4. The method according to claim 1, wherein the laminate comprises two base layers being bonded, respectively, to the opposite sides of said reinforcing layer; wherein the base layers have a thickness of about 0.060 inch and about 0.095 inch, respectively; and wherein said flock fibers are applied to the exposed surface of each of said base layer.

5. The method according to claim 2 further comprising moving the exposed surface of the base layer while under compression in tangential engagement with the ribs of the printing roll, and supplying adhesive to the surface of the roll moving toward the place of tangency.

6. The method according to claim 5 further comprising wiping the adhesive from the apices of the ribs, using a “doctor blade,” leaving the adhesive substantially exclusively in the grooves between the ribs.

7. The method according to claim 1 further comprising providing an adhesive for bonding the flock fibers to the exposed surface of the base layer which is free from metallic salt complex catalyst and which is of a viscosity such that it can be spread evenly over the exposed surface of the base layer and is sufficiently tacky when spread to insure adhesion of the flock fibers upon contact.

8. The method according to claim 1 further comprising providing an adhesive which is free of acid salt complex or metallic salt complex catalysts, when applied has a viscosity in the order of less than about 5 cps and a pH value of from about 4.0 to about 4.5 and is such that when cured it forms a transparent film and that to protect the base layer from the action of ultraviolet light contains an ultraviolet absorber.

9. The method according to claim 1, further comprising providing adhesive which comprises a base of a self-cross-linking acrylic emulsion having substantially the following physical properties, namely viscosity at 25° C., 200 cps; a density at 25° C. of 8.8 lbs. per gallon; a film break-elongation load of 620 p.s.i. and a film hardness of 32 Shore (A scale) but modifying the viscosity of the adhesive so provided by the addition of 0.5% of a thickener so that it will not penetrate substantially into the foam ply.

10. The method according to claim 1, further comprising providing an adhesive which, when applied as a liquid, has a viscosity of the order of less than about 5 c.p.s.

11. The method according to claim 1, wherein when applying the flock fibers, relatively long fibers of substantially uniform length of from about 1.6 mm to about 1.9 mm are first distributed relatively sparsely over the entire area of the base layer surface and, before the adhesive has set, shorter fibers of substantially uniform length of the order of about 1.6 mm in length and in quantity are distributed relatively closely over the entire area of the base layer surface to fill the spaces between the long fibers.

12. An article of manufacture made according to claim 1, comprising:
a reinforcing layer of textile fabric;
a base layer bonded to said reinforcing layer of textile fabric; and
flock fibers secured to the exposed surface of the base layer in a discontinuous coating of cured adhesive;
wherein said flock fibers are oriented substantially perpendicular to the surface of the base layer.

13. The article of manufacture according to claim 12, wherein the adhesive is dispersed so that there are discrete areas of adhesive interspersed with discrete areas substantially bare of adhesive.

14. The article of manufacture according to claim 12, wherein parallel grooves break the continuity of the adhesive coating, the grooves being of such width and so spaced that there are approximately about 25 grooves per inch.

15. The article of manufacture according to claim 12, wherein the reinforcing layer comprises an open-mesh textile fabric interposed between and bonded permanently to two base layers, and wherein the flock fibers are adhesively bonded to the exposed surface of each respective base layer.

16. The article according to claim 12, wherein the adhesive comprises an ultraviolet absorber such as substantially to prevent discoloration of the form when exposed to ultraviolet light.

17. The article according to claim 12, wherein the reinforcing layer is delustered to minimize the evidence of the presence of the reinforcing layer in the completed article.

18. The article according to claim 12, wherein the exposed surface of the base layer is overlain by upstanding flock fibers of two different lengths, the major portion of the flock fibers being of the shorter length and being uniformly and closely spaced and the longer fibers being less closely spaced and uniformly distributed among the shorter fibers, said long and short fibers covering the entire exposed surface of the base layer and collectively imparting to the article the appearance and feel of conventional nap such as results from napping of woven blanket cloth.

19. The article according to claim 12, wherein the exposed surface of the base layer is overlain by upstanding flock fibers of a uniform flock length.

20. The article of manufacture according to claim 12, wherein the adhesive which bonds the flock fibers to the exposed surface of the base layer is free of salt complex catalysts.

21. The article of manufacture according to claim 12, wherein the adhesive which bonds the flock fibers to the exposed surface of the base layer comprises from about 0.2% to about 1% of the ultraviolet absorber.

22. A heat-insulating material, comprising:
a reinforcing layer;
a base layer bonded to said reinforcing layer and having a thickness of less than 0.0625 inch; and
flock fibers secured to an exposed surface of the base layer through a discontinuous coating of cured adhesive.

23. The heat-insulating material according to claim 22, wherein the base layer has a thickness of less than about 0.060 inch.

24. The heat-insulating material according to claim 22, wherein the base layer has a thickness of more than about 0.055 inch.

25. The heat-insulating material according to claim 22, wherein the base layer has a thickness of about 0.059 inch.

26. The heat-insulating material according to claim 22, wherein the base layer has a thickness of about 0.058 inch.

27. The heat-insulating material according to claim 22, wherein the base layer has a thickness of about 0.057 inch.

28. The heat-insulating material according to claim 22, wherein the base layer has a thickness of about 0.056 inch.

29. The heat-insulating material according to claim 22, wherein the flock fibers are made of polyester.

30. The heat-insulating material according to claim 22, wherein said flock fibers have a diameter of more than about 3 denier but no more than about 4 denier.

31. The heat-insulating material according to claim 22, wherein said flock fibers have a diameter of about 2.2 denier.

32. The heat-insulating material according to claim 22, wherein said flock fibers have a diameter of about 3.3 denier.

33. The heat-insulating material according to claim 22, wherein the base layer comprises a pattern on its exposed surface, and wherein the flock fibers are transparent to reveal such pattern.

34. The heat-insulating material according to claim 22, wherein the base layer comprises an open-cell low density polyurethane foam material.
